(19) United States
(12) Patent Application Publication
(10) Pub. No.: US 2024/0319058 A1
(43) Pub. Date: Sep. 26, 2024

(54) Shock Test Machine with Interchangeable Excitation System and Isolated Resonant Plate Restraints

(71) Applicant: Carl Lee Sisemore, Cedar Crest, NM (US)

(72) Inventor: Carl Lee Sisemore, Cedar Crest, NM (US)

(21) Appl. No.: 18/186,330

(22) Filed: Mar. 20, 2023

(51) Int. Cl. G01N 3/30

(52) U.S. Cl. CPC G01N 3/30; G01N 2203/001; G01N 2203/0039; G01N 2203/0044

(57) ABSTRACT

A horizontal resonant plate style shock test machine for simulating pyroshock in the laboratory is provided. In particular, the shock test machine integrates an interchangeable pneumatic hammer excitation system operably coupled with an interchangeable pneumatic gas accumulator system such that the provided shock excitation is optimizable for the desired resonant plate parameters. The shock test machine also integrates moveable supports for the resonant plates that allow for the utilization of various shapes and sizes of resonant plate. The moveable supports also ensure optimum alignment between the pneumatic hammer excitation system and the resonant plate. The shock test machine also integrates a novel resonant plate restraint system that significantly restricts resonant plate motion during the shock test but allows the plate to freely vibrate within the restraints to correctly simulate a pyroshock event.

### PRIOR ART

U.S. Pat. No. 5,565,626 October 1996 Davie
U.S. Pat. No. 5,003,811 April 1991 Shannon et al.
U.S. Pat. No. 10,481,057 November 2019 Song et al.
U.S. Pat. No. 8,479,557 July 2013 Bottlinger et al.
KR 20220151369A
KR 20170084541A
RU 2595322C9
CN 103604578B
CN 104266814B

### BACKGROUND OF THE INVENTION

This invention relates generally to simulated pyroshock test in a shock test laboratory. In particular, the invention relates to horizontally mounted resonant plate shock test machines utilizing interchangeable pneumatically actuated projectile systems. Interchangeable hammer systems allows for greater tailoring and optimization of the pyroshock simulation, especially at very high frequencies. Additionally, the plates must be carefully aligned with the hammer system for testing accuracy while simultaneously being able to vibrate freely.

Simulating explosive shock or pyroshock in the laboratory has been done for many years with resonating fixture shock test machines. Most of these shock machines are resonating plate type machines. A resonating plate shock machine uses a large solid metallic plate designed with a primary excitation frequency and vibration mode corresponding to the excitation frequency expected in the real pyroshock environment. These plates are typically excited by pendulum hammers or with pneumatically actuated gas gun projectile style hammers. While the plates must be changed to match the primary excitation frequency, the pneumatic hammer system is generally unchanged. Hammer weights may be changed; however, without the ability to interchange the pneumatic hammer barrels, the range of potential hammer weights is severely limited.

### SUMMARY OF THE INVENTION

Conventional resonant plate shock test machines yield disadvantages addressed by various exemplary embodiments of the present invention. Various exemplary embodiments provide a pneumatically actuated projectile hammer system with a removable and replaceable barrel and projectile system supporting various bore diameters along with removable and replaceable gas accumulator tanks that optimized the gas quantity used in the pneumatic projectile system. The pneumatically actuated projectile hammer system and accumulator tanks are supported by a robust shock test machine structure consisting of a plurality of structural legs, cross-members, and braces. The system also incorporates a pair of movable resonant plate support rails operably attached to the upper surface of the shock test machine structure. These movable rails can accommodate various physical sizes and shapes of resonating plates in a horizontal configuration. Various sizes and shapes of resonant plates are frequently utilized to tailor the desired pyroshock test parameters. The resonant plates are operably secured to the movable resonant plate support rails through a plurality of shock isolated attachment points. Various exemplary embodiments of the shock isolated attachment points maintain operable alignment of the resonant plate and the pneumatic hammer system while simultaneously ensuring that the resonant plate is operably able to vibrate freely after impact.

### BRIEF DESCRIPTION OF DRAWINGS

These and various other features and aspects of various exemplary embodiments will be readily understood with reference to the following detailed description taken in conjunction with the accompanying drawings, in which like or similar numbers are used throughout, and in which:

FIG. 1 is a perspective view of the resonant plate shock test machine front with a prototypical resonant plate mounted on the machine;

FIG. 2 is a perspective view of the resonant plate shock test machine rear with a prototypical resonant plate mounted on the machine;

FIG. 3 is an exploded perspective view of the resonant plate shock test machine with the resonant plate removed and the hammer projectile visible;

FIG. 4 is a detailed perspective view of the lower pneumatic hammer system and its interface to the shock test machine structure and the gas control system;

FIG. 5 is a detailed perspective view of the movable resonant plate support rails and their method of interface to the shock test machine structure;

FIG. 6 is a detailed perspective view of the removable pneumatic gas accumulator tank;

FIG. 7 is a detailed perspective view of the shock test machine pneumatic control valve system; and

FIG. 8 is a detailed perspective view of one of the resonant plate attachment points illustrating the resonant plate isolation system that prevents significant vertical motion.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not taken in a limiting sense, and the scope of the present invention is defined only by the appended claims.

Various exemplary embodiments provide a horizontally mounted resonant plate pyroshock test machine with a readily interchangeable pneumatic excitation system that affords optimizing the machine to the desired shock environment. The shock test machine includes a readily removable and replaceable pneumatic hammer system mounted beneath the resonant plate. The machine also includes a removable and replaceable pneumatic accumulator tank permitting matching gas volume with the hammer system volume. The machine also includes a movable resonant plate support system that can accommodate different resonant plate sizes and shapes while simultaneously restraining the plate from any significant vertical motion during the shock event and subsequently isolating the vibrating plate from the shock machine.

While other resonant plate style shock test machines are available, the resonant plate shock test machine, according to an inventive embodiment, adapts an interchangeable pneumatic hammer system and accumulator tank to facilitate significantly increased optimization and tuning of the desired shock environment. This is necessary for optimizing resonant plate shock testing since very high-frequency tests require small diameter, lightweight hammers while low-frequency tests typically require larger diameter, heavier hammers. Since the hammer diameter needs to match the inner diameter of the pneumatic hammer barrel, interchangeable hammer systems represent a significant improvement over the current state of the art. Also, changing the barrel diameter changes the internal gas volume of the hammer system. This necessitates a corresponding change in the volume of the gas accumulator tank and a need for an interchangeable accumulator tank system. Too large of an accumulator tank can cause the hammer to be held against the resonant plate after a shock or can result in multiple shocks being applied during the test. Too small of an accumulator tank will not have sufficient gas to drive the hammer into the resonant plate with the necessary velocity to impart the desired shock environment.

This inventive embodiment of the resonant plate shock test machine also adapts moveable resonant plate support rails and isolated resonant plate restraints. The moveable resonant plate support rails can accommodate multiple sizes and shapes of resonant plates. The isolated resonant plate restraints restrain significant vertical motion of the resonant plate during the shock environment, while simultaneously isolating the resonant plate vibration from the shock test machine. True pyroshock testing requires negligible overall displacement of the resonant plate, which the restraints ensure. However, the plate also needs to vibrate freely during and after the shock event. In this embodiment of the invention, the resonant plate restraints incorporate felt isolators to separate the vibrating resonant plate from the restraints.

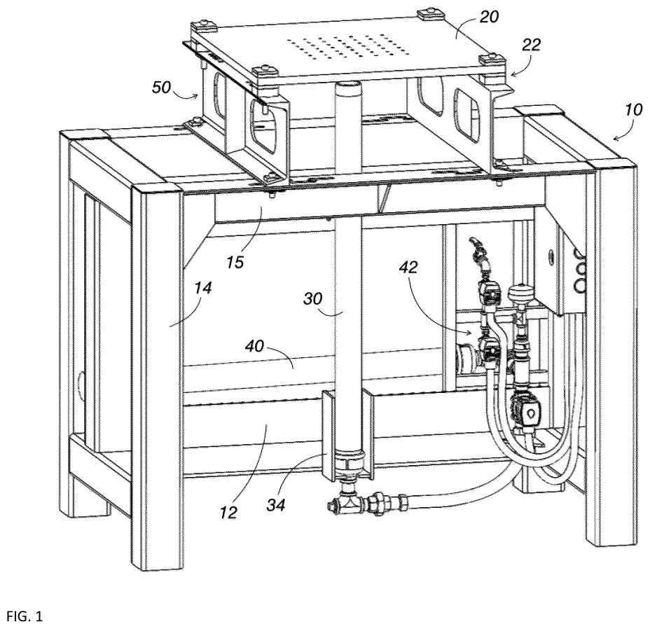

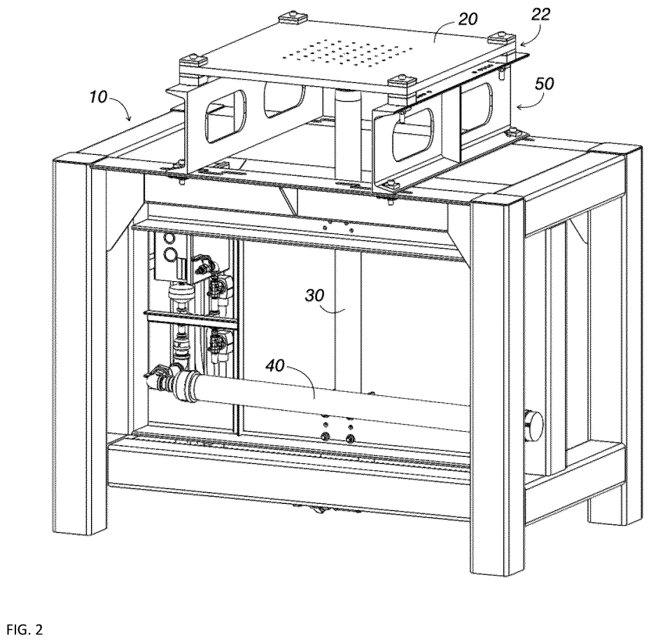

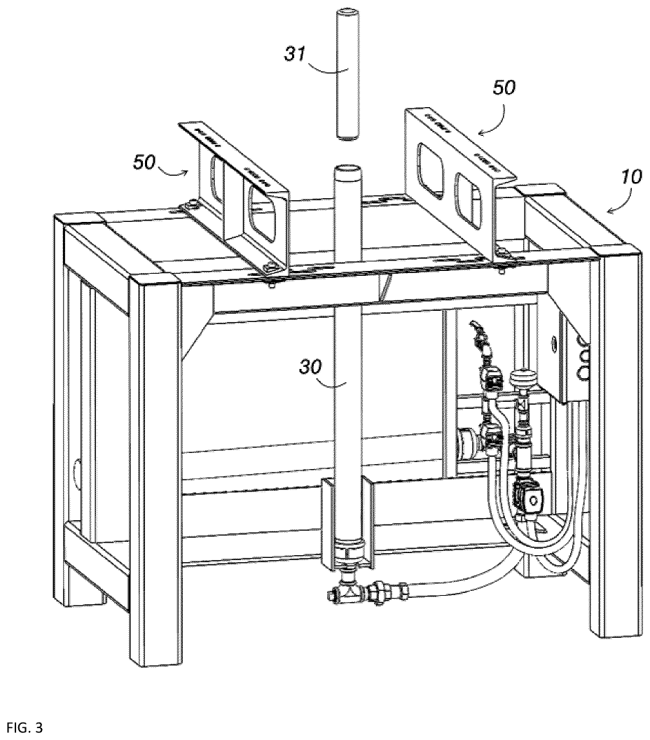

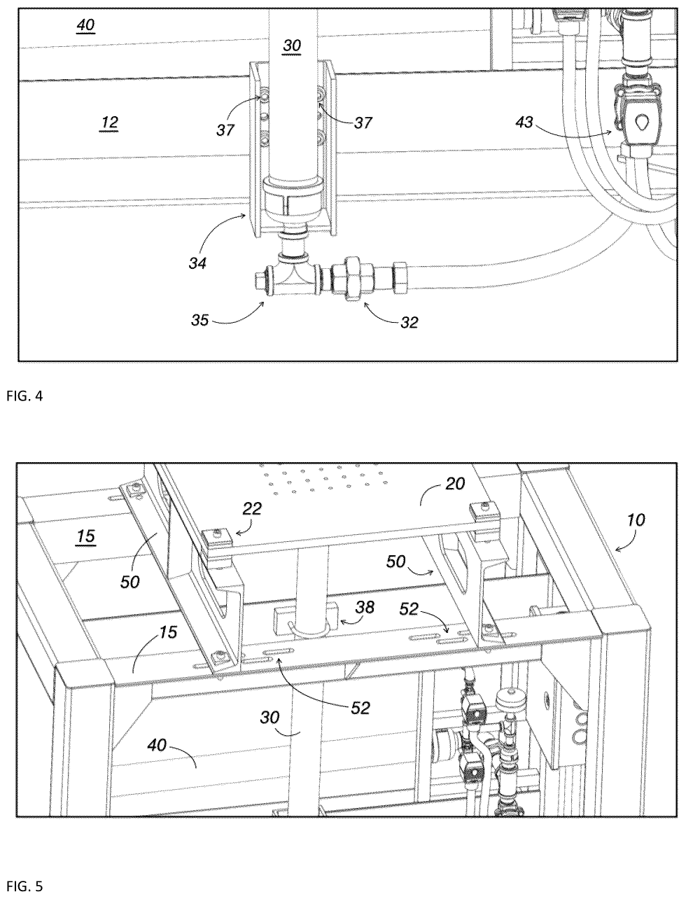

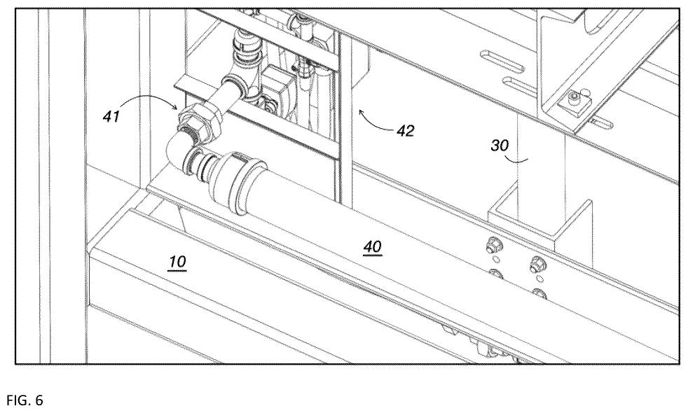

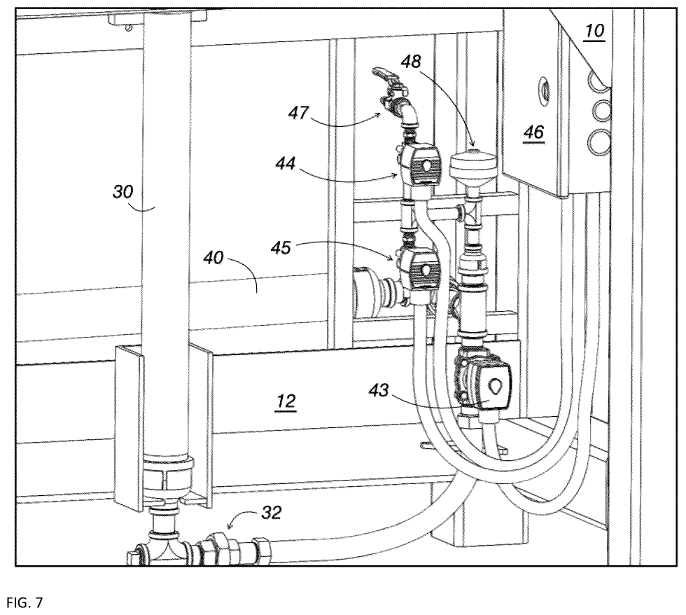

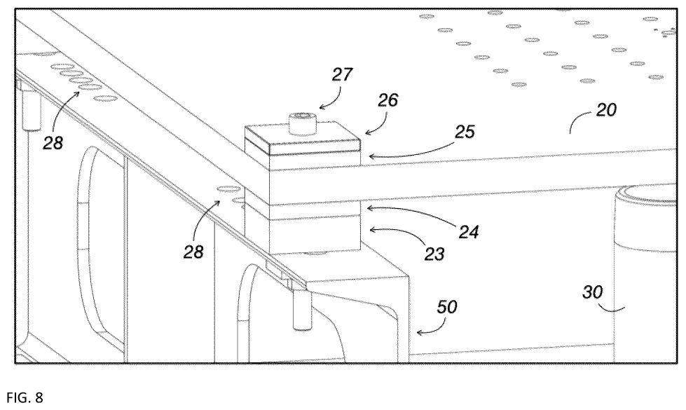

FIGS. 1 through 8 show a horizontal resonant plate shock test machine 10 including a prototypical resonant plate 20 mounted on moveable support rails 50 with resonant plate restraints 22. The interchangeable pneumatic hammer barrel 30 is vertically oriented below the resonant plate in the interchangeable breech support 34 attached to the barrel support bar 12. The interchangeable gas accumulator tank 40 is mounted behind the pneumatic hammer barrel 30. Both the hammer barrel 30 and the accumulator tank 40 are operably interfaced through the gas control piping and valves 42. FIG. 1 shows a perspective view of the resonant plate shock test machine front. FIG. 2 shows a perspective view of the resonant plate shock test machine rear. FIG. 3 shows an exploded perspective view of the resonant plate shock test machine with the resonant plate removed and the hammer projectile 31 visible above the hammer barrel 30. FIG. 4 shows a detailed perspective view of the lower pneumatic hammer system breech area and its interface to the shock test machine barrel support bar 12. FIG. 5 is a detailed perspective view of the movable resonant plate support rails 50 and their method of interface to the shock test machine structure 10. FIG. 6 shows a detailed perspective view of the removable pneumatic gas accumulator tank 40. FIG. 7 shows a detailed perspective view of the shock test machine pneumatic control valve system. FIG. 8 shows a detailed perspective view of one of the resonant plate attachment points illustrating the multi-layer resonant plate restraint and isolation system.

FIG. 1 shows the front of the resonant plate shock test machine 10 in a perspective view. The shock test machine 10 consists of the machine frame as well as the pneumatic components and resonant plate support and interface components. The shock machine 10 can have a plurality of legs 14. A plurality of upper support rails 15 and other cross-members can be incorporated as necessary for structural integrity. A primary barrel support rail 12 is positioned low on the shock test machine 10 to interface with the breech support 34 and to react the pneumatic hammer 30 recoil load. The pneumatic hammer 30 rests in the breech support 34, which supports the pneumatic hammer and transfers the recoil load to the shock machine frame 10. The moveable plate support rails 50 rest on and secure to the upper support rails 15. The resonant plate 20 operably interfaces to the support rails 50 through the resonant plate restraints 22. The pneumatic control valve system 42 is located to one side of the shock test machine 10. The interchangeable gas accumulator 40 is nominally positioned towards the machine rear and interfaces with the control valve system 42. Alternate locations can be contemplated for the gas accumulator 40 and the control valve system 42 within the scope of the inventive concepts herein.

FIG. 1 shows a resonant plate 20 that is square and relatively thin mounted on the shock test machine 10. However, numerous shapes and thicknesses could be easily integrated by moving the plate support rails 50. For example, the present embodiment of the invention has been tested with a round resonant plate in place of the square plate shown herein. The present embodiment has also been tested with significantly thicker square resonant plates.

FIG. 2 shows the rear of the resonant plate shock test machine 10 in a perspective view. The pneumatic gas accumulator tank 40 is shown mounted low across the machine rear. The pneumatic hammer 30 is shown oriented vertically at the center of the shock machine frame. A prototypical resonant plate 20 is shown mounted to the moveable support rails 50 through the resonant plate restraints 22.

FIG. 3 shows an exploded perspective view of the resonant plate shock test machine 10 with the resonant plate removed and the hammer projectile 31 visible above the pneumatic hammer barrel 30. The hammer projectile 31 can be made of many different materials and be of differing lengths and shapes to obtain the desired weight. The exterior dimensions of the hammer projectile 31 must be slightly smaller than the interior dimensions of the pneumatic hammer barrel 31 in order to ensure a that the hammer projectile 31 travels freely in the hammer barrel 30 and that the combination produces a reasonable gas seal between the parts. In the present embodiment of the shock test machine, the hammer projectile 31 is cylindrical and formed from steel. The resonant plate would be installed atop the moveable plate support rails 50, which prevents the hammer projectile 31 from leaving the hammer barrel 30 during a normal shock test.

FIG. 4 shows a detailed perspective view of the lower pneumatic hammer system breech area and its interface to the shock test machine primary barrel support bar 12. In the present embodiment of the shock machine, the pneumatic hammer barrel 30 rests in the breech support 34, which is fastened to the primary barrel support bar 12 using a plurality of fasteners 37. In the present embodiment, a plurality of bolts are used to operably connect the breech support 34 to the primary barrel support bar 12; however, any form of removable attachment mechanism could be utilized. The breech support 34 is interchangeable because various pneumatic hammer barrel embodiments 30 will necessarily require corresponding changes in the breech support 34. The interchangeable breech support 34 also allows for accommodating some variability in the length of the pneumatic barrel 30.

FIG. 4 also shows the lower pneumatic gas transfer path from the pneumatic gas accumulator tank 40 through the shock initiation valve 43 and into the pneumatic hammer barrel 30. The inventive embodiment of the shock machine includes a simple separable connection 32 that allows the pneumatic hammer barrel 30 to be readily removed from the pneumatic control system. This separable connection 32 allows the pneumatic hammer barrel 30 to be quickly and easily interchanged to accommodate different pyroshock test configurations. Additional pneumatic couplings 35 are needed in the present embodiment of the invention to redirect the pneumatic gas flow from the pneumatic control system located on the side into the base of the pneumatic hammer barrel. Alternative embodiments of this gas flow arrangement are easily contemplated and can be substituted within the scope of the inventive concepts herein.

FIG. 5 shows a detailed perspective view of the movable resonant plate support rails 50 and their method of interface to the shock test machine structure 10. In the present embodiment of the invention, a series of slots 52 are formed in the upper support rails 15. The slots are symmetrically located about the centerline of the pneumatic hammer 30 and allow for repositioning the resonant plate moveable support rails 50 to accommodate multiple plate shapes and sizes. The present embodiment of the shock machine incorporates bolts to secure the moveable support rails 50 to the upper support rails 15. Alternative embodiments of this variable positioning attachment mechanism are easily contemplated within the scope of this inventive concepts herein.

FIG. 5 also shows the upper attachment point 38 for the pneumatic hammer barrel 30. In the present embodiment of the invention, the upper attachment point 38 is a simple removable band style clamp with a calibrated spacer block attached to the shock machine frame 10. This ensures that the pneumatic hammer barrel 30 is both oriented vertically and aligned with the desired impact point on the resonant plate 20. Alternative embodiments of this attachment mechanism are easily contemplated and substituted within the scope of the inventive concepts herein.

FIG. 6 shows a detailed perspective view of the removable pneumatic gas accumulator tank 40 positioned inside the shock test machine 10 and located to the rear of the pneumatic control system 42 and the pneumatic hammer barrel 30. The present embodiment of the invention locates the accumulator tank 40 to the rear for convenience; however, other accumulator tank locations could be easily substituted within the scope of the inventive concepts detailed herein. The pneumatic gas accumulator tank 40 is operably attached to the pneumatic control system 42 through a simple separable connection 41. This separable connection 41 allows the pneumatic accumulator tank 40 to be quickly and easily interchanged to accommodate different sizes of the pneumatic hammer barrel 30. A novel embodiment of this invention is the ability to volumetrically match the pneumatic accumulator tank 40 to the nominal volume of the pneumatic hammer barrel 30.

FIG. 7 shows a detailed perspective view of the shock test machine pneumatic control valve system. In the present embodiment of the invention, the pneumatic control valves are electrically actuated with all electrical signals being passed through the electrical connection cabinet 46 mounted on the shock test machine 10. Different pneumatic control actuation methods could be contemplated within the scope of the inventive concepts detailed herein. The present embodiment of the pneumatic control system requires the introduction of compressed gas through the main control valve 47. Compressed gas is obtained from an external source. In the present embodiment, the main control valve 47 is a manually actuated valve for safety. Other options for the main valve 47 could be contemplated or the valve could be removed altogether.

The operation of the pneumatic control system is elucidated herein. Prior to performing a shock test, the fill control valve 44 is actuated open to allow the compressed gas to flow into the pneumatic control system and pressurize the pneumatic accumulator tank 40. A pressure monitoring gauge 48 is used to ensure the desired tank pressure is reached. Once the desired pressure in the accumulator tank 40 is reached, the fill control valve 44 is returned to its normally closed state. The shock machine is now ready to execute the shock test. If there is a need to abort the shock test, a vent valve 45 can be opened to vent the pressure in the accumulator tank 40 to atmosphere. With the accumulator tank pressurized to the desired pressure, a shock test is executed by opening the shock initiation valve 43. Opening the shock initiation valve 43 allows the compressed gas in the accumulator tank 40 to flow through the pneumatic control system, through the separable coupling 32 and into the breech area of the pneumatic hammer barrel 30. This sudden introduction of compressed gas at the breech of the pneumatic hammer barrel 30 in turn causes the hammer projectile to accelerate up the hammer barrel length and strike the bottom of the resonant plate, imparting a high-energy shock to the resonant plate and any system mounted thereon for testing. After striking the resonant plate, the projectile will naturally fall back to the breech of the hammer barrel, automatically resetting for the next shock test. To perform a subsequent shock, the accumulator tank, which is now empty, must be refilled with compressed gas as elucidated above. Other operationally similar arrangements and physical locations of the pneumatic valves and pressure monitoring systems could be readily contemplated.

FIG. 8 shows a detailed perspective view of one of a plurality of resonant plate attachment points. The inventive embodiment of these attachment points ensures that the plate is both simultaneously restrained from significant vertical and lateral motion and able to vibrate freely during the shock excitation. The multilayer arrangement consists of a spacer block 23 consisting of a relatively stiff material. This spacer block ensures no contact between the resonant plate 20 and the moveable support rails 50. The thickness of the space block 23 could also be used to accommodate variations in the length of the pneumatic hammer barrel 30. A relatively soft interface material 24 is inserted between the spacer block 23 and the resonant plate 20. In the present embodiment of the invention the interface material 24 is a hard felt although other materials could be substituted. A second, upper interface material 25, nominally identical to the lower interface material 24, is installed on top of the resonant plate 20 and a thick structural washer 26 is installed above the second piece of interface material 25. A fastener 27 operably passes through and attaches the structural washer 26, the upper interface material 25, the resonant plate 20, the lower interface material 24 and the space block 23 to the moveable support rail 50. In the present embodiment of the invention, the fastener 27 is a standard bolt, although other types of fasteners could be contemplated within the scope of the inventive concepts detailed herein. It is important that the fastener 27 only loosely couples the plate restraint stack together. Fastener 27 cannot be so tight that the interface materials 24 and 25 becomes crushed, which would prevent free vibration of the resonant plate 20 during the shock event.

FIG. 8 also shows a plurality of interface holes 28 in the upper surface of the resonant plate moveable support rail 50 in the present embodiment of the shock test machine. These holes are symmetrically located about the centerline of the pneumatic hammer 30 and allow for various resonant plate sizes to be used on the same shock test machine. The symmetry of the interface homes 28 also ensures alignment of the resonant plate to the pneumatic hammer 30 for various resonant plate sizes. Other interface arrangement, such as slots, could be substituted the interface holes 28 with no change in functionality.

While certain features of the embodiments of the invention have been illustrated as described herein, many modifications, substitutions, changes, and equivalents will now occur to those skilled in the art. It is therefore, to be understood that the appended claims are intended to cover all such modifications and changes as fall within the true spirit of the embodiments.

1. A horizontally oriented resonant plate style pyroshock test machine excited with a vertically oriented pneumatically actuated projectile hammer system, said assembly comprising: a support structure operable to mount a pneumatic hammer system, accumulator tank, and resonant plate; said pneumatic hammer system being readily removable and interchangeable with hammer systems of various diameters; said accumulator tank being readily removable and interchangeable with accumulator tanks of various volumetric capacity and operably matched to the pneumatic hammer system; said resonant plate being readily removable and interchangeable with resonant plates of various sizes and shapes.

2. The resonant plate shock test machine of claim 1, further comprising: a readily removable pneumatically actuated projectile hammer system permitting substantially different bore diameter projectile tubes to operably interface with the same pneumatic control system.

3. The resonant plate shock test machine of claim 1, further comprising: a readily removable pneumatic accumulator tank permitting substantially different volume capacity tanks to operably interface with the same pneumatic control system.

4. The resonant plate shock test machine of claim 1, further comprising: a plurality of movable resonant plate support rails operably attached to the support structure; a plurality of movable resonant plate support rails that are used to maintain operable alignment of the resonant plate to the pneumatically actuated projectile hammer through a plurality of attachment points.

5. The resonant plate shock test machine of claim 1, further comprising: a plurality of resonant plate attachment points that maintain operable plate alignment while simultaneously ensuring that the resonant plate is operably able to vibrate freely after a shock excitation; a plurality of resonant plate attachment points that simultaneously prevent significant vertical travel of the resonant plate during the shock excitation event.
